(19) United States
(12) Patent Application Publication
(10) Pub. No.: US 2009/0033494 A1
(43) Pub. Date: Feb. 5, 2009

(54) VEHICULAR MOBILE RF TAGS

(75) Inventor: Ajay Malik, Santa Clara, CA (US)

Correspondence Address: INGRASSIA FISHER & LORENZ, P.C. (Symbol), 7010 E. COCHISE ROAD, SCOTTSDALE, AZ, 85253-1406, US

(73) Assignee: SYMBOL TECHNOLOGIES, INC., Holtsville, NY (US)

(21) Appl. No.: 11/831,329

(22) Filed: Jul. 31, 2007

(51) Int. Cl. G08B 13/14

(52) U.S. Cl. 340/572.1

(57) ABSTRACT

A mobile radio frequency (RF) tag for a motor vehicle includes an antenna. A RF transceiver is coupled to the antenna. A processor compatible with a mobile phone protocol is coupled to the RF transceiver. The processor is configured to receive an activation signal and transmit a tracking signal over a control communications channel of the mobile phone protocol. A power lead is coupled to the processor. The power lead is configured to couple to a voltage supply of the motor vehicle.

### TECHNICAL FIELD

The present invention relates generally to radio frequency (RF) communications devices, and more particularly, to an apparatus and method for a trackable RF tag compliant with mobile telephone protocols configured for placement in motor vehicles.

### BACKGROUND

In recent years, there has been a dramatic increase in demand for mobile connectivity solutions utilizing various wireless components. In addition, businesses and individuals increasingly are in pursuit of so-called “just-in-time” actionable information, referring to just the right information, at the right time, at the right location, on any device, from which they can make effective decisions and take immediate action.

To further this pursuit, several location application services, or location-based services, have emerged. The use of radio frequency identification (RFID) tags is such a service which incorporates location technology in miniaturized form. Although locator tags such as RFID or 802.11 “Wi-Fi” tags have become commonplace, they generally have an accompanying limited range. Additionally, technologies such as RFID often require specialized equipment such as readers to operate.

Accordingly, it is desirable to provide a location technology enabled device which allows for greater range and flexibility of implementation and operation, such as in the placement of motor vehicles. Other desirable features and characteristics will become apparent from the subsequent detailed description and the appended claims, taken in conjunction with the accompanying drawings and the foregoing technical field and background.

### BRIEF SUMMARY

In one embodiment, by way of example only, a mobile radio frequency (RF) tag includes an antenna, and an RF transceiver coupled to the antenna. A processor, compatible with a mobile phone protocol, is coupled to the RF transceiver and configured to receive an activation signal and transmit a tracking signal over a control communications channel of the mobile phone protocol. A power lead is coupled to the processor. The power lead is configured to couple to a voltage supply of the motor vehicle.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview of an exemplary mobile radio frequency (RF) tag network;

FIG. 2 is a block diagram of an exemplary mobile radio frequency (RF) tag for use in a motor vehicle;

FIG. 3 is a flow chart diagram of an exemplary method of using the mobile radio frequency (RF) tag illustrated in FIG. 2; and

FIG. 4 illustrates an exemplary graphical user interface (GUI) of a mobile device.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

Various aspects of the exemplary embodiments may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements and/or the like, which may carry out a variety of functions under the control of one or more microprocessors or other control devices. In addition, the present invention may be practiced in conjunction with any number of data transmission protocols and that the system described herein is merely one exemplary application for the invention.

For the sake of brevity, conventional techniques related to signal processing, data transmission, signaling, network control, the IEEE 802.11 family of specifications, and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

Various so-called “tags” incorporating location technology include 802.11 “Wi-Fi” tags, “Bluetooth” tags, the aforementioned RFID tags, and global positioning system (GPS) type tags. 802.11 Wi-Fi tags make use of standard Wi-Fi infrastructure and the applications can locate them as they are identified as a Wi-Fi device in the network. Wi-Fi tags are local area network (LAN) tags. To implement such tags, a specific infrastructure is needed in each facility.

Bluetooth tags make use of a Bluetooth infrastructure and are also LAN-type tags. Specific infrastructure is needed in each local facility to accommodate such a tag. Passive/Active RFID tags make use of a respective RFID infrastructure and the applications can locate them. Again, RFID tags are LAN-type tags, requiring specific infrastructure and equipment. GPS tags make use of a respective GPS infrastructure. GPS-type tags require additional infrastructure resources such as radio frequency (RF) or Wi-Fi to send location information to external applications. In each of the foregoing cases, tags are resource intensive in that they require specific infrastructure to implement. Even once such a system is implemented, however, the tags may have limited range of operability. For example, RFID devices generally operate as part of a LAN. Such issues are difficult to overcome when an object is inherently mobile across a wide area, such as a motor vehicle.

A so-called “mobile radio-frequency (RF) tag” can be implemented in motor vehicles which serves to solve many of the aforementioned difficulties associated with current location tags, such as traditional RFID tags. The mobile RF tag includes components such as a microprocessor and transceiver which is compliant and compatible with existing mobile telephone (cellular phone) protocols and infrastructures. By nature, such a tag is a wide area network (WAN)-type tag. No local facility or infrastructure, such as readers or local base stations, is needed for operation. Mobile RF tags can make use of existing cellular telephone infrastructure and networks to provide operational functionality across wide ranges. The mobile RF tag can be coupled to a voltage source supplied by the vehicle itself (i.e., the vehicle battery) to provide for long operational life.

Mobile RF tags can be, for example, sold and activated by cell phone providers. Additionally, end users can buy and activate tags at a time that the end user purchased a respective tag or mobile device such as a cellular phone, or at a later stage. End users may attach mobile RF tags to various objects of interest. Some examples of the objects could be keys, a mobile device such as a cell phone, a vehicle, or other objects. The mobile RF tags utilize existing cell phone infrastructures to transmit a tracking signal to a cell phone tower, and to a respective base station. Using various technologies, such as application program interfaces (APIs), the tracking information can be relayed to and viewed on an end user's mobile device, such as his cell phone.

Because mobile RF tags do not require such traditional cellular phone components such as a speaker, or the analog to digital (A/D) and digital to analog (D/A) conversion processing circuitry, the tags can incorporate a minimum amount of communications circuitry which may be imbedded or integrated into the tag. For example, a tag can minimally include a processor, transceiver, memory, and an antenna which is integrated into an encapsulant, as will be further described.

Because the tag is electrically coupled to the power system of the motor vehicle, the RF tag can flexibly continuously operate for the lifetime of the vehicle battery. Conceivably, however, the RF tag could continue to operate indefinitely, as once a failed battery is replaced, the tag again becomes operational. In other embodiments, the tag could include a small battery integrated into the tag itself which provides power for temporary periods in the event of a loss of power from the vehicle. In such an implementation, a mobile RF tag can reliably operate for many years.

The mobile RF tags can utilize the preexisting control communications channel portion of wireless telephone networks to send and receive the relatively limited amount of associated data. Use of such control channels by cell phone providers to send and receive activation and tracking information does not impede bandwidth in the voice communications channels and can provide providers with additional sources of revenue. Such functionality will be further described below.

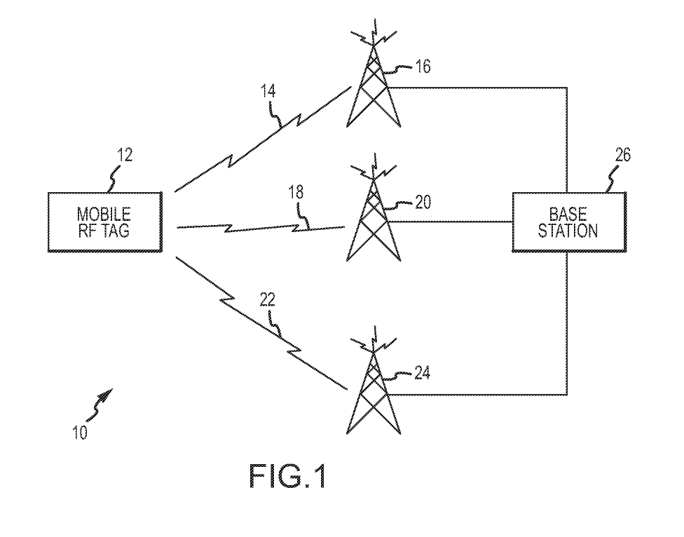

Turning to FIG. 1, a conceptual diagram of an implementation 10 of a mobile RF tag is shown. A mobile RF tag 12 is shown sending a RF tracking signal 14 to tower 16. Similarly, tag 12 sends signal 18 which is received by tower 20. Signal 22 is received by tower 24. Each tower 16, 20, and 24 are coupled to a base station 26 which can perform such functions as calculating a location of the tag 12 based on triangulation of the signals 14, 18, and 22 received by towers 16, 20, and 24.

Implementation 10 can be designed to be compatible with a wide variety of existing mobile phone protocols. For example, implementation 10 can be compatible and compliant with a time division multiple access (TDMA), code division multiple access (CDMA), wideband code division multiple access (W-CDMA), global system for mobile communications (GSM), general packet radio service (GPRS), evolution data optimized (EV-DO), and a third generation (3G) communications protocol. In some embodiments, implementation 10 can incorporate other communications standards for a particular application, such as Bluetooth or an integrated digital enhanced network (iDEN) standard.

In addition to receiving a tracking signal, the base station 26 can send an activation signal via towers 16, 20, and 24 to an unactivated tag 12. As one skilled in the art will appreciate, a processor integrated into the tag 12 can be set to an activation “sleep” mode, where the tag 12 listens for an activation signal but does not consume power by transmitting data. Once the tag 12 receives and registers the activation signal, the processor can instruct the tag to transmit a tracking signal which contains identification associated with the tag 12. Such activation signals and tracking signals need not contain a great deal of data. Further, a tracking signal need not be broadcast continuously. For example, a tag 12 can be programmed to send a tracking signal in “bursts” over predetermined time intervals to consume less power.

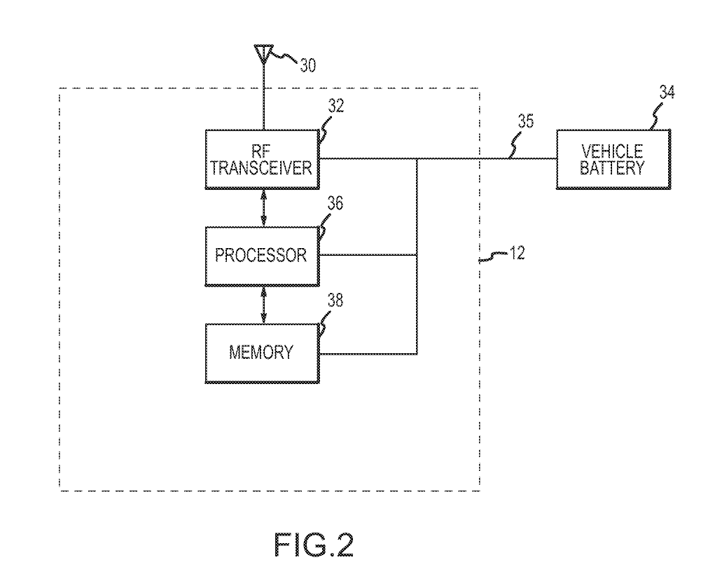

FIG. 2 illustrates a block diagram of an exemplary mobile RF tag 12. As stated previously, tag 12 includes such minimalist components as an antenna 30 coupled to an RF transceiver device 32. Transceiver 32, processor 34, and memory 38 each receive power from a power source/voltage source of the vehicle 34, such as the vehicle battery 34. Tag 12 includes a power lead 35 which is configurable to couple to the voltage source. As one skilled in the art will appreciate, power lead 35 may be manifest in a variety of implementations to suit a particular application. For example, a wire harness (not shown) may couple the power lead 35 to a voltage source 34 of the motor vehicle. Components such as antenna 30, transceiver 34, processor 36, and memory 38 can vary according to those known in the art and used in mobile devices such as cell phones.

In addition, however, as one skilled in the art would anticipate, the various components 32, 34, 36, and 38 can incorporate design attributes which reflect that the components will not be used in a traditional “voice communications” cellular phone scenario. For example, processing capabilities of processor 36 which may relate to converting analog signals to digital signals, or vice-versa, may be removed. Similarly, machine instructions relating to cellular phone capabilities such as display drivers and the like may be omitted. Only that functionality relating to the receipt and transmission of a small amount of digital information need be retained.

Along these lines, functionality depicted in memory block 38 may, in some embodiments, be integrated into the processing circuitry of the processor 36 device itself. Indeed, RF transceiver 34, processor 36, memory 38, and antenna 30 may be integrated over a single portion of substrate to provide for a smaller footprint. Again, the substrate may then be encapsulated (not shown) into a tag 12 package.

Further, since the tag 12 will be incorporated into a motor vehicle setting, the tag may be integrated with other vehicular electronic components. For example, the tag 12 may be incorporated on a single chipset with other processors 36, memory devices 38, etc. which are used for other vehicular applications, such as a vehicle electronic stability control (ESC) processor (e.g., a “vehicle processor device”). As such, RF transceiver 34, processor 36 and memory 38 may be designed to share a voltage source with the additional vehicle electronic components.

An exemplary mobile RF tag 12 may receive an activation signal via antenna 30 and through transceiver 32 which is registered by processor 36. As a next step, the processor 36 may interrogate memory 38 for specific identification information. For example, a specific “tag identification number” (TIN) or “tag serial number” (TSN) may be assigned in memory 38. The TIN or TSN may be associated with a specific vehicle identification number (VIN). The TIN, TSN, and/or VIN may be then transmitted, again via transceiver 32 and antenna 30 as a tracking signal. Other data may also be integrated into the tracking signal and/or selectively transmitted. For example, if processor 36 registers a particular predetermined supply voltage (reflecting a dying vehicle battery 34), the tag 12 can send a few extra bits of digital information reflecting the health of the battery to the wireless network.

Cell phones and base stations transmit or communicate with each other on dedicated paired frequencies called channels. Base stations use one frequency of that channel and mobile devices use the other frequency. A certain amount of bandwidth called an offset separates these frequencies. Certain channels carry only cellular system data, which can be referred to as “control communication channels.” This control channel is usually the first channel in each cell. The control channel is responsible for call setup. In fact, many radio engineers refer to the control channel as a “setup channel.” Voice channels, by comparison, are those paired frequencies which handle a call's traffic, be it voice or data, as well as signaling information about the call itself.

A cell or sector's first channel is always the control or setup channel for each cell. A region of 21 cells generally contains 21 control channels. A call is initiated on the control channel first. The control channel becomes unused once the respective call is assigned a so-called “voice channel.” The voice channel then handles the conversation as well as further signaling between the mobile device and a respective base station.

Mobile RF tag can receive an activation signal and send a tracking signal using a portion of the control channel spectrum. For example, depending on the mobile phone protocol in use, a subchannel of the overall control channel may be dedicated to handling tracking signal traffic, in much the same way that short message service (SMS) traffic is delivered over a subchannel of the overall control channel. Alternatively, an activation and tracking signal can travel over a voice channels of the network, again, taking up limited bandwidth.

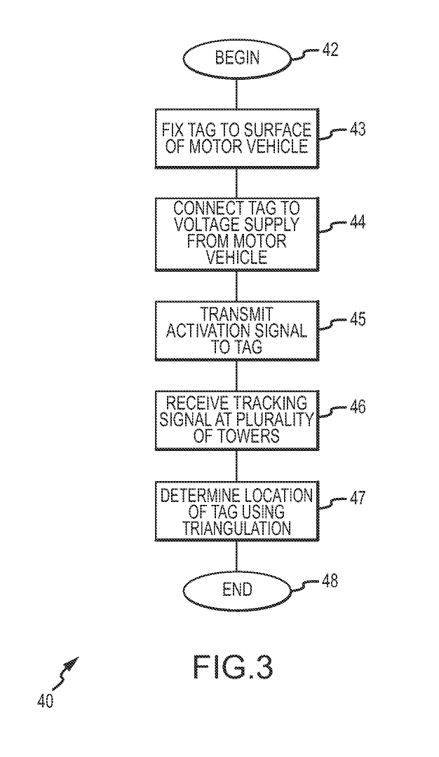

FIG. 3 is a flow chart diagram illustrating an exemplary method 40 of using a mobile RF tag. An end user may purchase such a tag, affixing the tag to an object such as a vehicle. Method 40 begins (step 42) with the affixing of a tag to a surface of the motor vehicle (step 43). Again, as previously mentioned, the tag may also be integrated with other vehicular electronic components as an alternative. In either case, the tag is coupled via the power lead to a voltage supply from the motor vehicle (step 44). As a next step, the transmission of an activation signal via a mobile phone protocol to the tag is commenced (step 45). The tag then registers the activation signal and transmits a tracking signal, which is received at a plurality of cell phone towers (step 46). In the depicted method 40, a location of the mobile RF tag is determined by triangulating the received tracking signal from at least three towers (step 47), although in other embodiments, location information may be determined by other means. Method 40 then ends (step 48).

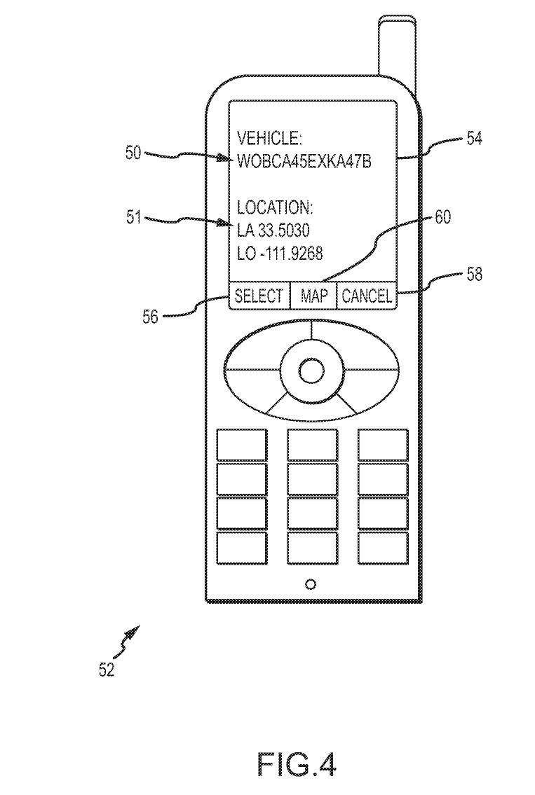

FIG. 4 illustrates an exemplary graphical user interface (GUI) of a mobile device 52 such as a cellular phone. In one embodiment, once the location of a mobile RF tag, and thereby, the vehicle, is determined, the location information can be directed to the mobile device 52 where it is displayed. Display 54 of the device 52 shows an exemplary message which may be displayed to an end user to indicate the location of a vehicle. Display 54 may include touch selectable menu options, such as select button 56, cancel button 58, and map button 60. In the depicted embodiment, the map button 60 may instruct the API executing on the device 52 to display a map, such as a street map, of the determined location of the vehicle/tag. In the depicted embodiment, the API displays the vehicle's VIN information (denoted by arrow 50) and the vehicle's respective latitude and longitude location information (denoted by arrow 51).

Mobile device 52 partially illustrates the flexibility of implementing vehicular mobile RF tags in an existing cellular phone network infrastructure. For example, an end user may purchase a mobile RF tag in conjunction with their new cellular phone. The user can then affix the tag to the vehicle in which the end user desires to monitor. As an alternative, when the end user purchases the vehicle, the tag and associated functionality may already be integrated into the vehicle. Location information sent as tracking signals from the tag can be interpreted by the cellular infrastructure and sent via the mobile phone protocol, or by other means, such as Bluetooth, to a mobile device. As a result, the end user has the power to determine a physical location of the vehicle in question in real time, at any time and from virtually any location accessible to the wireless network.

An additional exemplary method for using a vehicular mobile radio frequency tag may include fixing the tag on a surface of a motor vehicle, connecting a voltage supply of the motor vehicle to a power lead of the tag, transmitting an activation signal over a control communications channel of a mobile phone protocol to the tag, receiving the activation signal by means of an antenna and RF transceiver integrated into the tag, generating a tracking signal by means of a processor coupled to the RF transceiver and compatible with the mobile phone protocol, and transmitting the tracking signal over the control communications channel into a mobile phone network. The exemplary method may further include providing power to the processor via a battery integrated into the tag, transmitting the activation signal and tracking signal over a voice communications channel of the mobile phone protocol, receiving the tracking signal by a base station of the mobile phone network, determining a location of the tag by triangulating between the base station and at least two additional base stations, transmitting location data to a mobile device via the base station (including transmitting the location data with an unlicensed short range radio frequency specification for communications with the mobile device), storing identification information of the tag in a memory device coupled to the processor, retrieving the identification information from the memory device, and incorporating the identification information into the tracking signal.

The particular aspects and features described herein may be implemented in any manner. In various embodiments, the processes described above are implemented in software that executes within the processor 36, a base station, or elsewhere. This software may be in source or object code form, and may reside in any medium or media, including random access, read only, flash or other memory, as well as any magnetic, optical or other storage media. In other embodiments, the features described herein may be implemented in hardware, firmware and/or any other suitable logic.

It should be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A mobile radio frequency (RF) tag for a motor vehicle, comprising:
an antenna;
an RF transceiver coupled to the antenna; and
a processor, compatible with a mobile phone protocol, coupled to the RF transceiver and configured to receive an activation signal and transmit a tracking signal over a control communications channel of the mobile phone protocol; and
a power lead coupled to the processor configured to couple to a voltage supply of the motor vehicle.

2. The tag of claim 1, wherein the voltage supply of the motor vehicle is in electrical communication with a battery of the motor vehicle.

3. The tag of claim 1, further including a memory device coupled to the processor to store identification data.

4. The tag of claim 1, further including a vehicle processor device integrated with the processor into a single chipset.

5. The tag of claim 1, wherein the processor is configured to receive the activation signal and transmit the tracking signal over a voice communications channel of the mobile phone protocol.

6. The tag of claim 1, wherein the mobile phone protocol includes a time division multiple access (TDMA), code division multiple access (CDMA), wideband code division multiple access (W-CDMA), global system for mobile communications (GSM), general packet radio service (GPRS), evolution data optimized (EV-DO), or a third generation (3G) communications protocol.

7. The tag of claim 1, wherein a location of the tag is determined by a base station triangulating the tracking signal.

8. The tag of claim 7, wherein the location is transmitted to a mobile device via the mobile phone protocol.

9. The tag of claim 8, wherein the processor is compatible with an unlicensed short range radio frequency specification for communications with the mobile device.

10. A method for using a mobile radio frequency (RF) tag, comprising:
fixing the tag on a surface of a motor vehicle;
connecting a voltage supply of the motor vehicle to a power lead of the tag;
transmitting an activation signal over a control communications channel of a mobile phone protocol to the tag;
receiving the activation signal by means of an antenna and RF transceiver integrated into the tag;
generating a tracking signal by means of a processor coupled to the RF transceiver and compatible with the mobile phone protocol; and
transmitting the tracking signal over the control communications channel into a mobile phone network.

11. The method of claim 10, further including providing power to the processor via a battery of the motor vehicle in electrical communication with the voltage supply.

12. The method of claim 10, further including transmitting the activation signal and tracking signal over a voice communications channel of the mobile phone protocol.

13. The method of claim 10, wherein transmitting the tracking signal further includes transmitting a signal compliant with a time division multiple access (TDMA), code division multiple access (CDMA), wideband code division multiple access (W-CDMA), global system for mobile communications (GSM), general packet radio service (GPRS), evolution data optimized (EV-DO), or a third generation (3G) communications protocol.

14. The method of claim 10, further including receiving the tracking signal by a base station of the mobile phone network.

15. The method of claim 14, further including determining a location of the tag by triangulating between the base station and at least two additional base stations.

16. The method of claim 15, further including transmitting location data to a mobile device via the base station.

17. The method of claim 16, wherein transmitting the location data further includes transmitting the location data with an unlicensed short range radio frequency specification for communications with the mobile device.

18. The method of claim 10, further including storing identification information of the tag in a memory device coupled to the processor.

19. The method of claim 18, further including upon receiving the activation signal, retrieving the identification information from the memory device.

20. The method of claim 19, further including incorporating the identification information into the tracking signal.

21. A vehicular mobile radio frequency (RF) tag, comprising:
an antenna;
an RF transceiver coupled to the antenna for receiving an activation signal over a mobile phone protocol;
a processor coupled to the RF transceiver for processing the activation signal; and
a power lead coupled to the processor.

22. The tag of claim 21, wherein the power lead is coupled to a voltage supply of a motor vehicle.
